(19) United States
(12) Patent Application Publication
(10) Pub. No.: US 2026/0149945 A1
(43) Pub. Date: May 28, 2026

(54) COOPERATIVE POSITIONING USING MULTIPLE TECHNOLOGIES

(71) Applicant: QUALCOMM Incorporated, San Diego, CA (US)

(72) Inventors: Varun Amar REDDY, San Diego, CA (US); Alexandros MANOLAKOS, Athens (GR); Krishna Kiran MUKKAVILLI, San Diego, CA (US)

(21) Appl. No.: 19/124,152

(22) PCT Filed: Oct. 26, 2023
(86) PCT No.: PCT/US2023/036022

§ 371 Date: Apr. 24, 2025

(30) Foreign Application Priority Data
Dec. 19, 2022 (GR) 20220101052

(51) Int. Cl. H04W 4/02

(52) U.S. Cl. CPC H04W 4/02

(57) ABSTRACT

An example method of hybrid cooperative positioning performed by a server, the method comprising: requesting a capability report from each user equipment (UE) of one or more UEs. The method also comprises receiving a set of one or more capability reports and determining, based on the one or more capability reports, a device prioritization for configuring a hybrid cooperative positioning session utilizing each of a plurality of positioning technologies. The device prioritization comprises: a first prioritization of the plurality of positioning technologies, a second prioritization of one or more UEs that participate in the hybrid cooperative positioning session, or any combination thereof. The method also comprises transmitting, to the one or more UEs, a hybrid cooperative positioning session configuration determined based on the device prioritization.

### RELATED APPLICATIONS

This application claims the benefit of Greece Application No. 20220101052, filed Dec. 19, 2022, entitled “COOPERATIVE POSITIONING USING MULTIPLE TECHNOLOGIES”, which is assigned to the assignee hereof, and incorporated herein in its entirety by reference.

### BACKGROUND

### 1. Field of Disclosure

The present disclosure relates generally to the field of cooperative positioning of an electronic wireless device. More specifically the present disclosure relates to cooperative positioning using multiple positioning technologies.

### 2. Description of Related Art

The positioning of devices can have a wide range of consumer, industrial, commercial, military, and other applications. The position of a device can be estimated based on information gathered using different positioning technologies. For example, ultra-wideband (UWB)-based positioning offers a highly-accurate, low-power positioning solution relative to other radio frequency (RF)-based positioning techniques for wireless electronic devices. In many indoor scenarios, Wi-Fi-based positioning can also provide accurate position estimation to a target device using one or more Wi-Fi access points (APs). Moreover, a cellular network (e.g., implemented according to 5G New Radio (NR)) can also provide position solution(s) to the target device. Other positioning technologies such as visual positioning system and Quadrotor Dead Reckoning (QDR) can further provide information on vehicular positioning on the road.

### BRIEF SUMMARY

An example method of hybrid cooperative positioning performed by a server, the method comprising: requesting a capability report from each user equipment (UE) of one or more UEs. The method also comprises receiving a set of one or more capability reports and determining, based on the one or more capability reports, a device prioritization for configuring a hybrid cooperative positioning session utilizing each of a plurality of positioning technologies. The device prioritization comprises: a first prioritization of the plurality of positioning technologies, a second prioritization of one or more UEs that participate in the hybrid cooperative positioning session, or any combination thereof. The method also comprises transmitting, to the one or more UEs, a hybrid cooperative positioning session configuration determined based on the device prioritization.

An example method of hybrid cooperative positioning performed by a user equipment (UE), the method comprising: receiving, from a server, a capability report request and transmitting, to the server, the capability report. The method also comprises receiving, from the server, a hybrid cooperative positioning session configuration determined based on a device prioritization for a hybrid cooperative positioning session utilizing each of a plurality of positioning technologies. The device prioritization is determined based on the capability report. The device prioritization comprises: a first prioritization of the plurality of positioning technologies, a second prioritization of one or more UEs that participate the hybrid cooperative positioning session, or any combination thereof.

An example server comprising: one or more transceivers, a memory, and one or more processors communicatively coupled with the one or more transceivers and the memory. The one or more processors are configured to: request a capability report from each user equipment (UE) of one or more UEs and receive a set of one or more capability reports. The one or more processors are also configured to determine, based on the one or more capability reports, a device prioritization for configuring for a hybrid cooperative positioning session utilizing each of a plurality of positioning technologies. The device prioritization comprises: a first prioritization of the plurality of positioning technologies, a second prioritization of one or more participating UEs that participate in the hybrid cooperative positioning session, or any combination thereof. The one or more processors are also configured to transmit, to the one or more UEs, a hybrid cooperative positioning session configuration determined based on the device prioritization.

An example user equipment (UE) comprising: one or more transceivers, a memory, and one or more processors communicatively coupled with the one or more transceivers and the memory. The one or more processors are configured to: receive, from a server, a capability report request and transmit, to the server, the capability report. The one or more processors are also configured to receive, from the server, a hybrid cooperative positioning session configuration determined based on a device prioritization for a hybrid cooperative positioning session utilizing each of a plurality of positioning technologies. The device prioritization is determined based on the capability report. The device prioritization comprises: a first prioritization of the plurality of positioning technologies, a second prioritization of one or more UEs that participate the hybrid cooperative positioning session, or any combination thereof.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2A is a diagram illustrating a scenario in which both to ultra-wideband (UWB) and cellular (5G new radio (NR)) wireless technologies may be used for positioning a target device.

FIG. 2B is a simplified diagram illustrating how positioning of a target device may be performed, according to some embodiments.

FIG. 3 is a diagram illustrating how a sequential cooperative-positioning may be performed according to 5G NR.

FIG. 4 is a diagram illustrating how a joint cooperative-positioning may be performed according to 5G NR.

FIG. 5 is a flow diagram illustrating how an improved sequential hybrid cooperative-positioning may be performed, according to some embodiments.

FIG. 6 is a flow diagram illustrating how an improved joint hybrid cooperative-positioning may be performed, according to some embodiments.

FIG. 7 is a method of hybrid cooperative positioning performed by a server, according to some embodiments.

FIG. 8 is a method of hybrid cooperative positioning performed by a user device (UE), according to some embodiments.

FIG. 9 is a block diagram of an embodiment of a computer system, which can be utilized in embodiments as described herein.

FIG. 10 is a block diagram of an embodiment of a UE, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein (including, for example, UWB-based positioning, Wi-Fi-based positioning, cellular-based positioning, and hybrid cooperative positioning) may absolute location determination, relative location determination, ranging, or a combination thereof. Such positioning may include and/or be based on timing, angular, phase, or power measurements, or a combination thereof (which may include RF sensing measurements) for the purpose of location or sensing services.

When positioning target devices (e.g., using 5G New Radio (NR), Global Navigation Satellite System (GNSS), Wi-fi, etc.), instead of each target device being serviced by its own set of anchor nodes (e.g., noncooperative positioning), performing cooperative positioning where target devices also exchange measurements with each other (e.g., each target device not only measures the distance to the anchor nodes, but measures the distance to other target devices, and use all the collected ranging information to estimate the position) may largely improve the position estimation performance (e.g., improve the positioning accuracy and expands the coverage). For example, studies in NR positioning have shown that in non-line-of-sight (NLoS) scenarios between UEs and the NR NodeBs (gNBs), UEs that can make line-of-sight (LoS) measurements with other UEs saw enhanced position estimation performance compared with UEs implementing noncooperative positionings.

On the other hand, for target devices that support multiple positioning technologies, a hybrid positioning method that could utilize the multiple positioning technologies (e.g., coordinating different positioning technologies such as UWB, Wi-Fi, 5G NR, etc.) may further enhance the performance of the positioning.

Embodiments herein provide improved cooperative positioning using multiple technologies methods that can enhance the position estimation performance compared with existing positioning schemes.

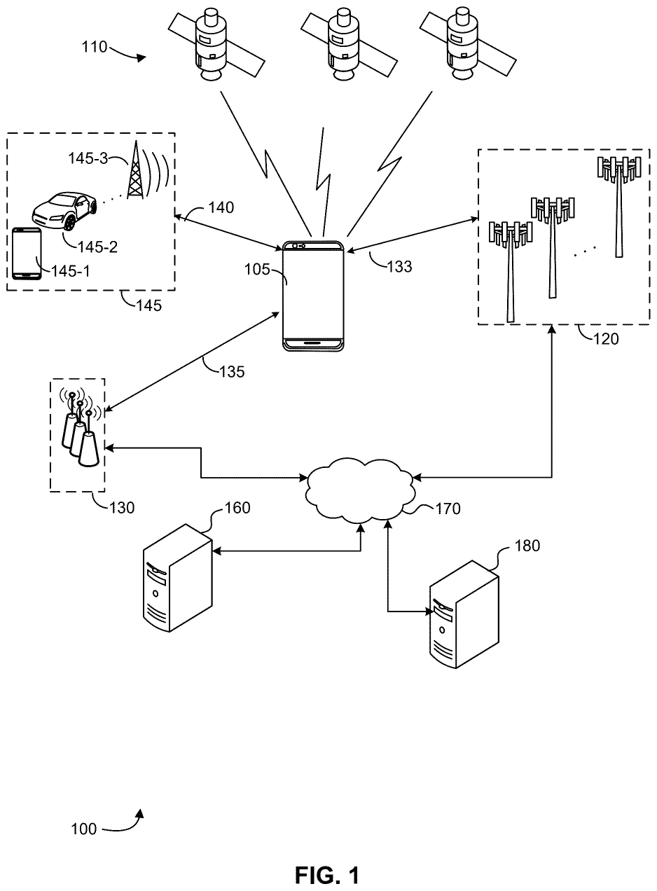

FIG. 1 is a simplified illustration of a positioning system 100 in which a UE 105, location server 160, and/or other components of the positioning system 100 can use the techniques provided herein for hybrid positioning, according to an embodiment. The techniques described herein may be implemented by one or more components of the positioning system 100. The positioning system 100 can include: a UE 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed hereafter.

It should be noted that FIG. 1 provides only a generalized illustration of various components, any or all of which may be utilized as appropriate, and each of which may be duplicated as necessary. Specifically, although only one UE 105 is illustrated, it will be understood that many mobile devices (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include an LTE wireless network, a Fifth Generation (5G) wireless network (also referred to as an NR wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network. In a wireless cellular network (e.g., LTE or 5G), the UE 105 may be referred to as a user equipment (UE)

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g., with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the UE 105 in one or more ways. For example, satellites 110 (also referred to as space vehicles (SVs)) may be part of a GNSS such as GPS, GLONASS, Galileo or Beidou. Positioning using RF signals from GNSS satellites may comprise measuring multiple GNSS signals at a GNSS receiver of the UE 105 to perform code-based and/or carrier-based positioning, which can be highly accurate. Additionally or alternatively, satellites 110 may be utilized for Non-Terrestrial Network (NTN)-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), UWB, IEEE 802.15x, or a combination thereof. Mobile devices 145 may additionally or alternatively use non-RF wireless signals for positioning of the UE 105, such as infrared signals or other optical technologies.

Mobile devices 145 may comprise other mobile devices communicatively coupled with a cellular or other mobile network (e.g., network 170). When one or more other mobile devices 145 are used in the position determination of a particular UE 105, the UE 105 for which the position is to be determined may be referred to as the “target mobile device,” and each of the other mobile devices 145 used may be referred to as an “anchor mobile device.” (In a cellular/mobile broadband network, the terms “anchor UE” and “target UE” may be used.) For position determination of a target mobile device, the respective positions of the one or more anchor mobile devices may be known and/or jointly determined with the target mobile device. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., UE 105) may be facilitated using measurements from one or more anchor devices (e.g., mobile devices 145).

According to some embodiments, such as when the UE 105 comprises and/or is incorporated into a vehicle, a form of D2D communication used by the UE 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g., to assist direction finding or navigation for a user of UE 105 or to assist another user (e.g., associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another mobile device) at some known previous time). A location may be specified as a geodetic location comprising coordinates which may be absolute (e.g., latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium, or convention center). A location may instead be a civic location and may then comprise one or more of a street address (e.g., including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g., a circle or ellipse) within which UE 105 is expected to be located with some level of confidence (e.g., 95% confidence).

The external client 180 may be a web server or remote application that may have some association with UE 105 (e.g., may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

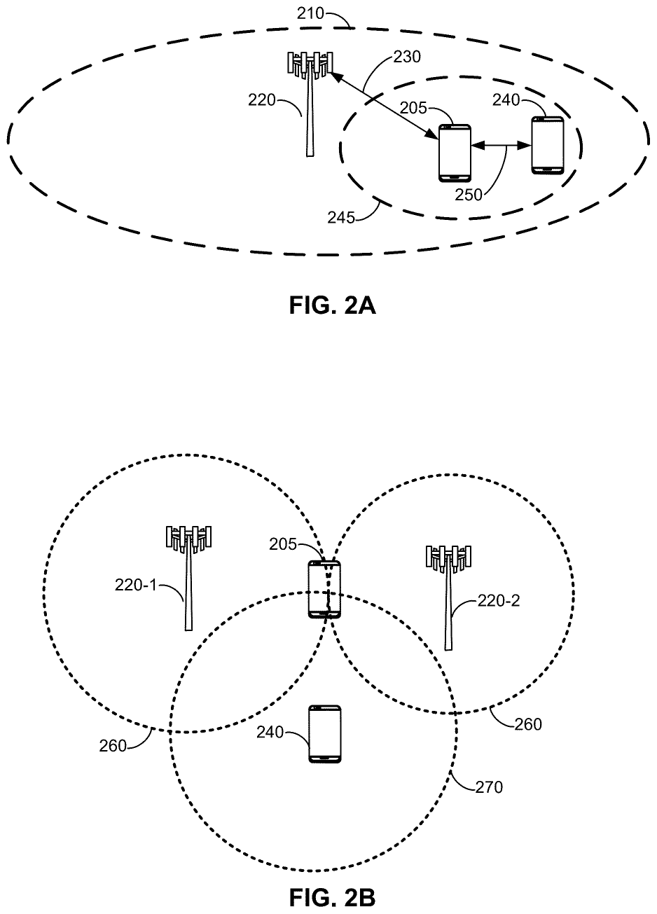

FIG. 2A is a diagram illustrating a scenario in which both UWB and cellular (5G NR) technologies may be used for positioning a target device 205. Here, target device 205 may correspond with UE 105 of FIG. 1. Generally put, according to some embodiments, the hybrid cellular/UWB positioning (or simply “cellular/UWB positioning”) of a device may utilize both cellular and UWB positioning technologies to determine the location of a device that is capable of taking positioning-related measurements in both cellular and UWB technologies. The use of both cellular and UWB technologies may utilize additional anchors (cellular and/or UWB anchors) for positioning measurements, which can allow for positioning of a device in situations where the use of a single technology would not, and/or increased accuracy over the use of a single technology. Hybrid cellular/UWB positioning also may be referred to as (hybrid) “5G/UWB” or “NR/UWB” positioning where cellular technology comprises 5G NR.

In this scenario, a target device 205 may comprise a UE of the cellular network within a coverage region 245 of a base station 220, which may comprise a serving base station of the target device 205. Communication between the base station 220 and target device 205 may occur across a network (Uu) interface 230, which may also be used to communicate DL and/or UL reference signals for cellular aspects of hybrid cellular UWB positioning. According to some embodiments, the positioning of the target device 205 may be coordinated by the network via a location server (not shown), and related configuration data and/or assistance data may be related to the target device 205 by the base station 220 via the network interface 230.

The UWB aspects of hybrid cellular/UWB positioning, the target device 205 may send and/or receive UWB RF signals from UWB device 240, acting as a UWB anchor. The UWB RF signals may be coordinated using an out of band (OOB) interface 250, which may utilize Bluetooth, Wi-Fi, or similar wireless technology, for example, which may have a corresponding wireless coverage region 245. According to some embodiments, the UWB aspects of hybrid cellular/UWB positioning may be coordinated by the target device 205 and/or UWB device 240, or maybe coordinated by location or other server (not shown). In some embodiments, configuration data and/or assistance data may be provided to a target device 205 and/or UWB device 240 directly by the base station 220. In some embodiments, configuration data and/or assistance data may be provided to a target device 205 directly by the base station 220 (e.g., via the network interface 230), and the target device 205 may relay the configuration data and/or assistance data to the UWB device 240 (e.g., via the OOB interface 250.

It can be noted that, although a single base station 220 and a single UWB device 240 are illustrated in FIG. 2, scenarios in which hybrid cellular/UWB positioning of a target device 205 may include one or more base stations and one or more UWB devices.

FIG. 2B is a simplified diagram illustrating how positioning of the target device 205 may be performed, according to some embodiments. Here, measurements using cellular technology may comprise round trip signal propagation delay (RTT) measurements performed between the target device 205 and each of a first base station 220-1 and a second the base station 220-2 to determine a distance between the target device 205 and the base stations 220. (These distances are represented by circles 260.) Additionally, as indicated, measurements and UWB may comprise RTT measurements (also referred to as two-way ranging (TWR) in UWB) performed to determine a distance between the target device 205 and one or more UWB anchors, such as UWB device 240. (The distance between the target device 205 and the UWB device 240 is represented by circles 270.) Using multilateration, the location of the target device 205 may be determined as location in which circles representing the distances (circles 260 and 270) intersect. Because the distances may have some uncertainty, the resulting location of the location of the target device 205 also may have some uncertainty.

As noted above, compared with the traditional noncooperative positioning method, the cooperative positioning method improves the positioning accuracy and expands the coverage. In the cooperative positioning method, the target node/device not only measures the distance to the reference/anchor node, but measures the distance to other target nodes, and use all the collected ranging information to estimate the position. At present, the UWB positioning methods are mainly divided into two types: sequential cooperative-positioning and joint cooperative-positioning.

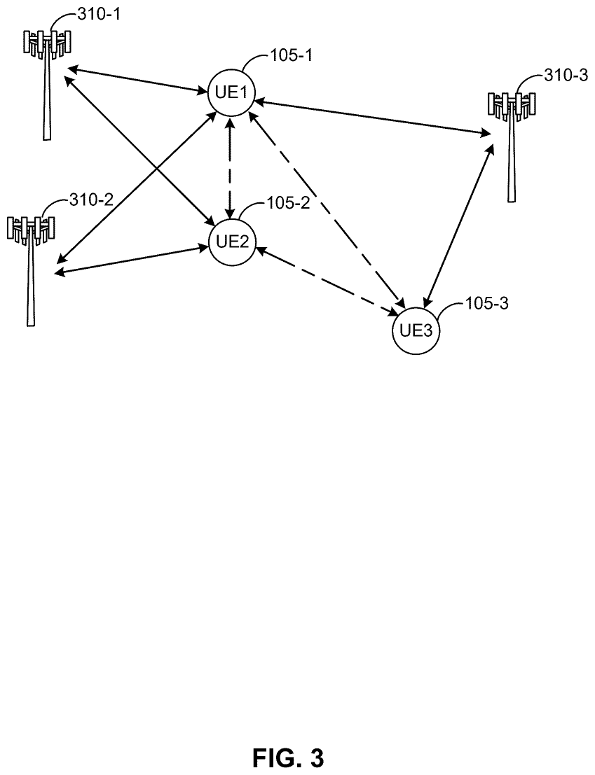

FIG. 3 is a diagram illustrating how a sequential cooperative-positioning may be performed according to 5G NR. As shown in FIG. 3, the sequential cooperative-positioning may be performed between anchor nodes 310 and UE 105. Here anchor nodes 310 may correspond to cellular anchors (e.g., base station 120 shown in FIG. 1 and base station 220 in FIGS. 2A and 2B). The use of 5G NR in this example is for illustrative purpose only and anchor nodes 310 may also or instead correspond to other types of anchors, such as UWB anchors (e.g., UWB device 240 in FIGS. 2A and 2B), APs for the Wi-Fi-based positioning, and/or reference nodes of other suitable positioning technologies. UE 105 may correspond with target device 205 or UWB device 240 of FIG. 2, or UE 105 of FIG. 1.

As indicated, in sequential cooperative-positioning for positioning one or more UEs 105, positioning measurements (e.g., multi-RTT, Time-Difference-of-Arrival (TDoA)) may be determined based on communications between anchor nodes 310 and UEs 105 (e.g., Uu links, shown in solid lines in FIG. 3), and communications between different UEs 105 (e.g., sidelink, shown in dash lines in FIG. 3).

For example, when performing the sequential cooperative-positioning, UEs 105 may be divided into two groups: list U containing UEs 105 to be positioned (e.g., target UEs) and list L containing UEs 105 with location estimates (e.g., anchor UEs). The sequential cooperative-positioning may start with positioning a first target UE (e.g., UE1 shown in FIG. 3). If the target UE has pervious location estimate(s) (e.g., UE1 is in the list L), the previous location estimate(s) may be ignored. The position estimate of the first target UE may be determined based on both Uu links (e.g., with anchor nodes 310) and sidelink (e.g., with other UEs 105). After having the location estimate, the first target UE may be added to list L for positioning other UEs 105. The process may then move to position a next target UE on list U until certain termination condition is met (will be discussed in more detail below).

According to the existing sequential cooperative-positioning schemes, the first target UE may be selected 1. according to a random selection; 2. as the UE with the most Uu links; 3. as the UE with the best expected positioning accuracy; or 4. as the UE with the most sidelink. The nth target UE to position may be selected 1. as the UE having the most sidelink connections with the UEs already positioned by the process (e.g., 1^{st}, 2^{nd}, 3^{rd}, . . . and n-1^{th} target UEs); 2. as one of the neighbor UEs of the n-1^{th} target UE; 3. a neighbor UE of the n-1^{th} target UE with the most Uu links; or 4. as the UE with the best expected positioning accuracy. The sequential cooperative-positioning may be terminated on condition that 1. the length of the position sequence reaches a threshold (e.g., when the sequential cooperative-positioning is set to position 20 target UEs and the process will be terminated when the 20^{th} target UE is positioned); 2. no undetermined/non-positioned UEs; or 3. no neighbor UEs to be positioned. In some scenarios, the sequential cooperative-positioning may be repeated for a predetermined number of iterations to enhanced performance, according to a same or a different position sequence.

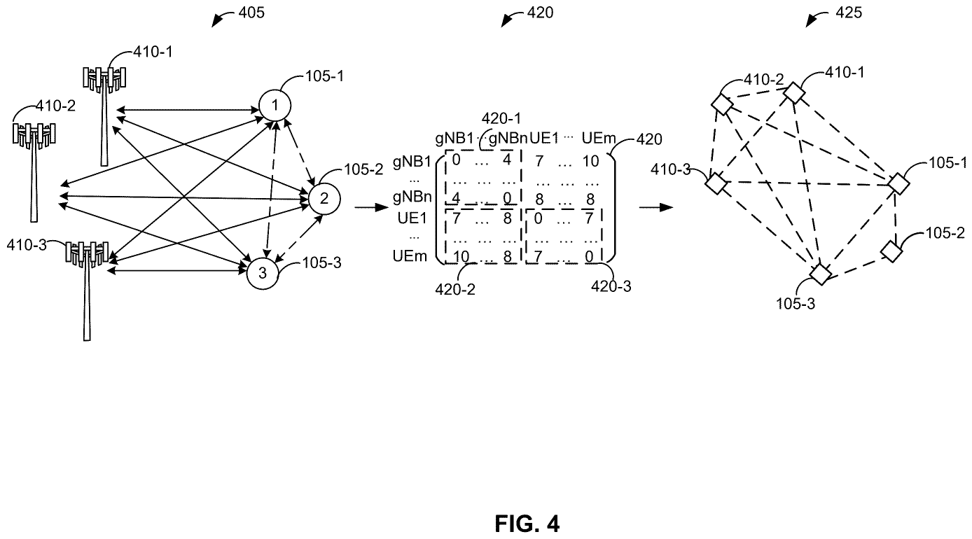

FIG. 4 is a diagram illustrating how a joint cooperative-positioning may be performed according to 5G NR. Similar to the sequential cooperative-positioning shown in FIG. 3, the joint cooperative-positioning may be performed between anchor nodes 410 and UE 105. Here anchor nodes 410 may correspond to cellular anchors (e.g., base station 120 shown in FIG. 1 and base station 220 in FIGS. 2A and 2B). It is contemplated that 5G NR is for illustrative purpose only and anchor nodes 410 may also correspond to UWB anchors (e.g., UWB device 240 in FIGS. 2A and 2B), APs for the Wi-Fi-based positioning, and/or reference nodes of other suitable positioning technologies. UE 105 may correspond with a target device 205 or UWB device 240 of FIG. 2, or UE 105 of FIG. 1.

As indicated, in joint cooperative-positioning for positioning one or more UEs 105, positioning measurements (e.g., multi-RTT, Time-Difference-of-Arrival (TDoA)) may be determined based on communications between anchor nodes 410 and UEs 105 (e.g., Uu links, shown in solid lines in FIG. 4), and communications between different UEs 105 (e.g., sidelink, shown in dash lines in FIG. 4). For example, in a scenario where N anchors (e.g., anchor nodes 410 and UEs 105 with known locations) are used to position M target UEs, the estimate positions of the M target UEs may be simultaneously determined based on multidimensional scaling (e.g., map an original high dimensional space to a lower dimensional space).

As shown in FIG. 4, an original layout 405 may include N anchors and M target UEs. All N anchors and M target UEs may be included in a distance matrix 420 where anchor node-UE and UE-UE distances are to be estimated with PRS measurements (e.g., multi-RTT) and the anchor node-anchor node distance are known. Accordingly, as shown in FIG. 4, distance matrix 420 may include a known portion 420-1, a Uu measurements portion 420-2, a sidelink measurements portion 420-3, and a transposed version of Uu measurements portion 420-2 (e.g., the upper-right corner of distance matrix 420). After determining the pairwise distances (e.g., the relative distances) between N anchors and M target UEs, original layout 405 may be reconstructed as a graph 425 that preserves the relative distance information as much as possible based on multidimensional scaling. Accordingly, the relative locations of the target UEs with regard to the anchors may be determined.

As noted above, cooperative positioning may provide performance improvements in positioning target devices. However, when multiple technologies and/or measurements are involved, the coordination among different technologies and/or the measurements (e.g., the sequence, priority, weights, and/or inclusion/exclusion of one or more technologies/target devices/measurements) could be challenging. The technical solutions described herein provides improved coordination techniques for performing cooperative positioning with multiple technologies (also referred as “hybrid cooperative positioning” hereinafter) that could enhance the performance of cooperative positioning (e.g., increase the accuracy and efficiency).

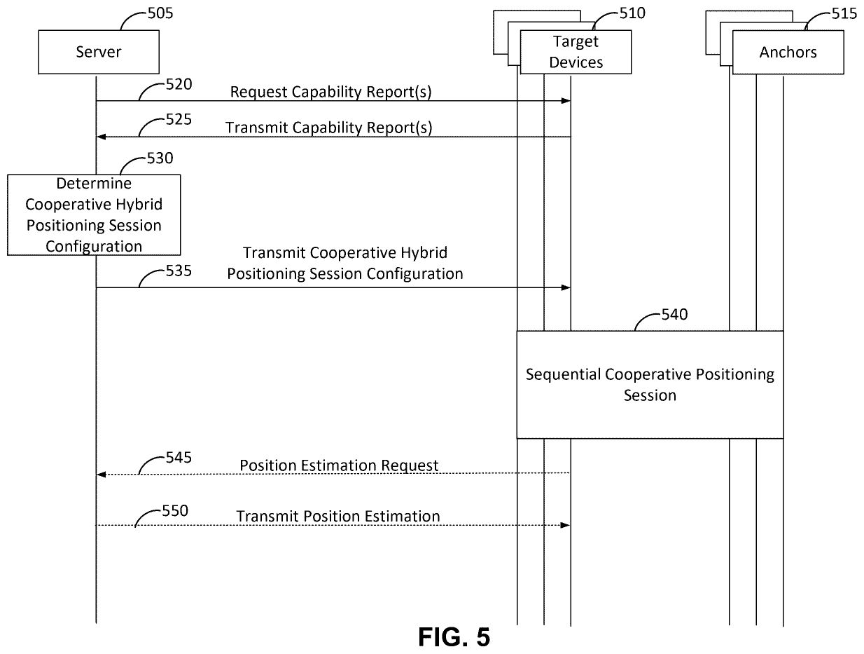

FIG. 5 is a flow diagram illustrating how an improved sequential hybrid cooperative-positioning (also referred as “sequential hybrid cooperative positioning” hereinafter) may be performed, according to some embodiments. In some embodiments, the improved sequential hybrid cooperative-positioning may be performed between a server 505, one or more target device 510, and one or more anchor 515. In some embodiments, server 505 may correspond to location server 160 in FIG. 1, a proprietary server or any other suitable servers. Target device 510 may be UEs capable of supporting different positioning technologies (e.g., UWB, Wi-Fi, 5G NR, Quadrotor Dead Reckoning (QDR), and/or visual positioning system) and may correspond with target device 205 or UWB device 240 of FIG. 2, mobile devices 145 or UE 105 of FIG. 1. Anchor 515 may correspond to anchors nodes 310 in FIG. 3, cellular anchors (e.g., base station 120 of FIG. 1 or base station 220 of FIGS. 2A and 2B), UWB anchors (e.g., UWB device 240 in FIGS. 2A and 2B), APs for the Wi-Fi-based positioning, and/or reference nodes of other suitable positioning technologies.

Starting at arrow 520, server 505 may request one or more capability reports from one or more target devices 510. In some embodiments, each capability report corresponds to one target devices 510 and may at least include parameters indicating whether the participating target device: 1. intends to participate in a sequential hybrid cooperative-positioning session utilizing each of a plurality of positioning technologies (e.g., Wi-Fi, UWB, NR, QDR, visual positioning system); 2. supports each of the plurality of positioning technologies; 3. supports one or more channels for the positioning; 4. a number of anchor nodes known by the UE; 5. a number of neighboring nodes known by the UE (e.g., anchor nodes that can be found by scanning a list of channels mentioned in the request); 6. types of measurements supported (e.g., ToA, AoA, AoD); 7. a link budget parameter of the target device (e.g., including the maximum transmit power, the number of transmitter antennas, the number of receiver antennas, noise figure, and/or figure of merit); or any combination thereof. In some embodiments, the link budget parameter of the target device may be restricted by access permissions (a device may choose to not reveal such information to the server).

In some embodiments, the capability report may also include parameters such as the desired position accuracy, configurations for the duty cycle, etc. In some embodiments, the corresponding information for each target device 510 may be represented/indicated by one or more predetermined bits of the exchanged messages. For example, at a predetermined slot, “0” may represent not participating the sequential hybrid cooperative positioning session and “1” may represent participating the sequential hybrid cooperative positioning session.

At arrow 525, target devices 510 may transmit the corresponding capability reports to server 505.

At block 530, server 505 may determine a sequential hybrid cooperative positioning session configuration based on the one or more capability reports. In some embodiments, the sequential hybrid cooperative positioning session configuration may be determined based on 1. a prioritization of the plurality of positioning measurements/technologies; and 2. a prioritization of one or more target devices 510 that participate the sequential hybrid cooperative positioning session.

As a non-limiting example, in a sequential hybrid cooperative positioning session that utilizes UWB-based and Wi-Fi-based positioning, the UWB-based positioning may be given a higher priority over the Wi-Fi-based positioning. In some embodiments, the prioritization may also be specific to certain type of measurements. As another non-limiting example, in the scenario stated above, UWB range measurements may be given a higher priority over sidelink range measurements, which in turn g may be given a higher priority over Wi-Fi range measurements.

In some embodiments, the prioritization of measurements/technologies may also be determined based on link quality. For example, if the link quality information is available (e.g., if the link quality may be determined in terms of link budget parameters or the figure of merit indicated in the capability reports), only a subset of the measurements/technologies may be chosen for positioning, determined on a threshold-base. For example, only measurements/technologies with link qualities higher than a predetermined threshold may be performed by the sequential hybrid cooperative positioning session.

In some embodiments, the prioritization of measurements/technologies may also be determined based on positioning accuracy. For example, during the iterative steps of the sequential cooperative positioning scheme, if a target device 510 has made various measurements using more than one technology in a previous iteration and observes that the position estimate obtained using each of the technologies alone converge to/diverge from a common estimate. The target device 510 may determine a confidence metric accordingly and report the confidence metric to server 505 (e.g., using the capability report). Server 505 may then prioritize such target device 510 in the order of sequential positioning.

In some embodiments, target devices 510 may be prioritized based on the number of unique measurements each target device 510 supports. For example, target devices 510 and/or links that can make different types of measurements using various technologies can provide greater degree of freedom in terms of dilution of precision (DOP), more reliability, and more useful information for enhancing the position accuracy. Thus, server 505 may prioritize those target devices 510 and/or links accordingly.

Accordingly, in the sequential hybrid cooperative positioning session configuration, measurements/technologies, anchors 515, and/or target devices 510 with higher priority may be performed earlier in the sequence.

In some embodiments, the sequential hybrid cooperative positioning session configuration may also include information of resource allocations for each of target devices 510. For example, the resource allocations for each of target devices 510 may include: (i) a time resource allocation, a frequency resource allocation, a spatial resource allocation, or any combination thereof; and (ii) an intended recipient for each ranging message. The sequential hybrid cooperative positioning session configuration may also include information of the number of iterations of the sequential hybrid cooperative positioning.

At arrow 535, server 505 may transmit the sequential hybrid cooperative positioning session configuration to target devices 510 that participate in the session (e.g., indicated in the corresponding capability report). In some embodiments, the sequential hybrid cooperative positioning session configuration may be included in the assistance data transmitted from server 505 to target devices 510.

At arrow 540, the sequential hybrid cooperative positioning session utilizing the plurality of positioning technologies may be performed between target devices 510 and one or more anchors 515 according to the sequential hybrid cooperative positioning session configuration. Detail of processes similar to the corresponding process in a conventional sequential cooperative positioning session is discussed with regard to FIG. 3 and will not be repeated for ease of illustration.

In some embodiments, if anchors 515 (e.g., base stations) may not be able to determine the position of target device 510 (e.g., do not include a positioning engine), the process may further include arrows 545 and 550, where target device 510 may transmit a position estimation request including the positioning measurements to server 505 for the position estimation (e.g., determined according to the sequential hybrid cooperative positioning session configuration), and in response to the request, server 505 may transmit the position estimation to the one or more target devices 510 making the request.

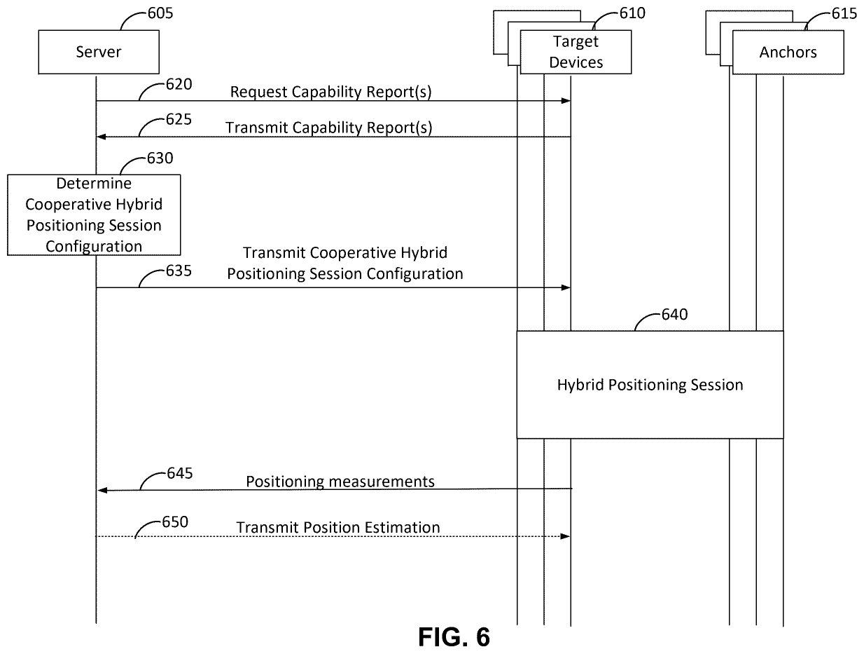

FIG. 6 is a flow diagram illustrating how an improved joint hybrid cooperative-positioning (also referred as “joint hybrid cooperative positioning” hereinafter) may be performed, according to some embodiments. Similar to the improved sequential hybrid cooperative-positioning in FIG. 5, in some embodiments, the joint hybrid cooperative-positioning may be performed between a server 605, one or more target devices 610, and one or more anchor 615. In some embodiments, server 605 may correspond to location server 160 in FIG. 1, a proprietary server or any other suitable servers. Target devices 610 may be UEs capable of supporting different positioning technologies (e.g., UWB, Wi-Fi, 5G NR, Quadrotor Dead Reckoning (QDR), and/or visual positioning system) and may correspond with target device 205 or UWB device 240 of FIG. 2, mobile devices 145 or UE 105 of FIG. 1. Anchor 615 may correspond to anchors nodes 310 in FIG. 3, cellular anchors (e.g., base station 120 of FIG. 1 or base station 220 of FIGS. 2A and 2B), UWB anchors (e.g., UWB device 240 in FIGS. 2A and 2B), APs for the Wi-Fi-based positioning, and/or reference nodes of other suitable positioning technologies.

Starting at arrows 620 and 625, server 605 may request one or more capability reports from one or more target devices 610 and target devices 610 may transmit the corresponding capability reports to server 605 accordingly, similar to the corresponding processes (e.g., arrows 520 and 525 respectively) in FIG. 5.

At block 630, server 605 may determine a joint hybrid cooperative positioning session configuration based on the one or more capability reports. In some embodiments, the sequential hybrid cooperative positioning session configuration may be determined based on 1. a prioritization of the plurality of positioning measurements/technologies; and 2. a prioritization of one or more target devices 610 that participate the joint hybrid cooperative positioning session.

As a non-limiting example, in a joint hybrid cooperative positioning session that utilizes UWB-based and Wi-Fi-based positioning, the UWB-based positioning may be given a higher priority over the Wi-Fi-based positioning. In some embodiments, the prioritization may also be specific to certain type of measurements. As another non-limiting example, in the scenario stated above, UWB range measurements may be given a higher priority over sidelink range measurements, which in turn g may be given a higher priority over Wi-Fi range measurements.

In some embodiments, the prioritization of measurements/technologies may also be determined based on link quality. For example, if the link quality information is available (e.g., if the link quality may be determined in terms of link budget parameters or the figure of merit indicated in the capability reports), only a subset of the measurements/technologies may be chosen for positioning, determined on a threshold-base. For example, only measurements/technologies with link qualities higher than a predetermined threshold may be performed by the joint hybrid cooperative positioning session.

In some embodiments, the prioritization of measurements/technologies may also be determined based on positioning accuracy. For example, during the iterative steps of the joint cooperative positioning scheme, if a target device 610 has made various measurements using more than one technology in a previous iteration and observes that the position estimate obtained using each of the technologies alone converge to/diverge from a common estimate. The target device 610 may determine a confidence metric accordingly and report the confidence metric to server 605 (e.g., using the capability report). Server 605 may then include the target device 610 with high priorities (e.g., a priority higher than a predetermined threshold) in the set of device-device measurements (e.g., the sidelink measurements portion 420-3 in FIG. 4) in joint hybrid cooperative positioning session.

In some embodiments, target devices 610 may be prioritized based on the number of unique measurements each target device 610 supports. For example, target devices 610 and/or links that can make different types of measurements using various technologies can provide greater degree of freedom in terms of dilution of precision (DOP), more reliability, and more useful information for enhancing the position accuracy. Thus, server 605 may prioritize those target devices 610 and/or links accordingly.

Accordingly, according to the joint hybrid cooperative positioning session configuration, server 605 may determine the inclusion/exclusion of measurements/technologies, anchor 615, and/or target devices 610 in the joint computation of the joint hybrid cooperative positioning session (e.g., in distance matrix 420 of FIG. 4). For example, measurements/technologies and/or target devices 610 with priorities lower than a predetermined threshold may be excluded from the joint computation of the joint hybrid cooperative positioning session.

In some embodiments, the joint hybrid cooperative positioning session configuration may also include information of resource allocations for each of target devices 610. For example, the resource allocations for each of target devices 610 may include: (i) a time resource allocation, a frequency resource allocation, a spatial resource allocation, or any combination thereof; and (ii) an intended recipient for each ranging message. The sequential hybrid cooperative positioning session configuration may also include information of the number of iterations of the hybrid cooperative positioning.

At arrow 635, server 605 may transmit the joint hybrid cooperative positioning session configuration to target devices 610 that participate in the session (e.g., indicated in the corresponding capability report). In some embodiments, the joint hybrid cooperative positioning session configuration may be included in the assistance data transmitted from server 605 to target devices 610.

At arrow 640, the joint hybrid cooperative positioning session utilizing the plurality of positioning technologies may be performed between target devices 610 and one or more anchors 615 according to the joint hybrid cooperative positioning session configuration. Detail of processes similar to the corresponding process of a conventional joint cooperative positioning session are discussed with regard to FIG. 4 and will not be repeated for ease of illustration.

In some embodiments, in arrow 645, target devices 610 may transmit to server 605 position estimation requests including the positioning measurements, requesting the position estimation (e.g., determined according to the joint hybrid cooperative positioning session configuration).

In response to the request, in some embodiments, the process may optionally include arrow 650 where server 605 may transmit the position estimation to the one or more target device 610 that requests the transmission of the position estimation.

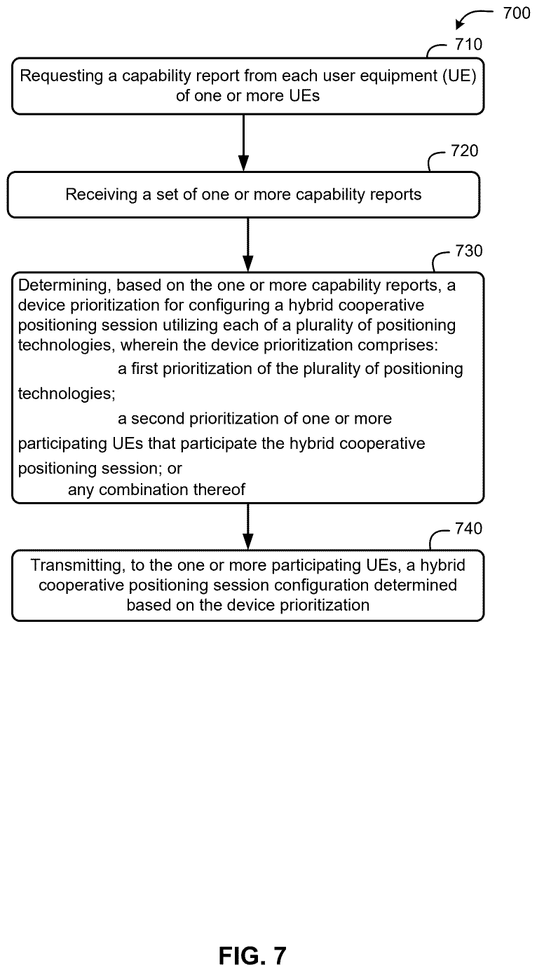

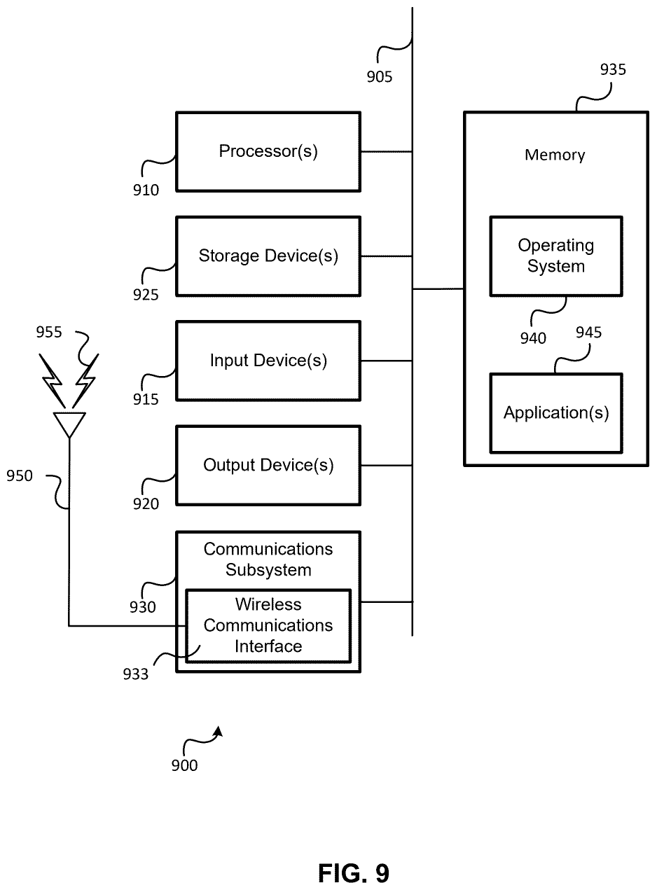

FIG. 7 is a method 700 of hybrid cooperative positioning performed by a server, according to some embodiments. In some embodiments, the server may correspond to location server 160 in FIG. 1, server 505 in FIG. 5, or server 605 in FIG. 6. Means for performing the functionality illustrated in one or more of the blocks shown in FIG. 7 may be performed by hardware and/or software components of a computer system. Example components of a computer system 900 are illustrated in FIG. 9, which is described in more detail below.

At block 710, the functionality comprises requesting a capability report from each user equipment (UE) of one or more UEs (e.g., target devices 510 in FIG. 5 or target device 610 in FIG. 6). Means for performing functionality at block 710 may comprise a bus 905, processor(s) 910, memory 935, wireless communication interface 933, and/or other components of computer system 900, as illustrated in FIG. 9.

As noted above, in some embodiments, each capability report corresponds to one UE and may at least include parameters indicating whether the participating UE: 1. intends to participate in a hybrid cooperative-positioning session utilizing each of a plurality of positioning technologies (e.g., Wi-Fi, UWB, NR, QDR, visual positioning system); 2. supports each of the plurality of positioning technologies; 3. supports one or more channels for the positioning; 4. a number of anchor nodes known by the UE; 5. a number of neighboring nodes known by the UE (e.g., anchor nodes that can be found by scanning a list of channels mentioned in the request); 6. types of measurements supported (e.g., ToA, AoA, AoD); 7. a link budget parameter of the target device (e.g., including the maximum transmit power, the number of transmitter antennas, the number of receiver antennas, noise figure, and/or figure of merit); or any combination thereof. In some embodiments, the link budget parameter of the target device may be restricted by access permissions (a device may choose to not reveal such information to the server).

In some embodiments, the capability report may also include parameters such as the desired position accuracy, configurations for the duty cycle, etc. In some embodiments, the corresponding information for each UE may be represented/indicated by one or more predetermined bits of the exchanged messages. For example, at a predetermined slot, “0” may represent not participating the sequential hybrid cooperative positioning session and “1” may represent participating the sequential hybrid cooperative positioning session.

At block 720, the functionality comprises receiving a set of one or more capability reports. In some embodiments, the set of one or more capability reports comprises a corresponding capability report from each of the one or more UEs. In some embodiments, for each respective UE of the one or more UEs, the corresponding capability report comprises parameters indicating: whether the respective UE intends to participate in a hybrid cooperative positioning session utilizing each of a plurality of positioning technologies; one or more of the plurality of positioning technologies supported by the respective UE; and one or more types of positioning measurements supported by the respective UE. Means for performing functionality at block 720 may comprise a bus 905, processor(s) 910, memory 935, wireless communication interface 933, and/or other components of computer system 900, as illustrated in FIG. 9.

At block 730, the functionality comprises determining, based on the one or more capability reports, a device prioritization for configuring the hybrid cooperative positioning session utilizing each of the plurality of positioning technologies, wherein the device prioritization comprises: a first prioritization of the plurality of positioning technologies; a second prioritization of one or more participating UEs that participate the hybrid cooperative positioning session; or any combination thereof. Means for performing functionality at block 730 may comprise a bus 905, processor(s) 910, memory 935, wireless communication interface 933, and/or other components of computer system 900, as illustrated in FIG. 9.

As noted above, as a non-limiting example, in a hybrid cooperative positioning session that utilizes UWB-based and Wi-Fi-based positioning, the UWB-based positioning may be given a higher priority over the Wi-Fi-based positioning. In some embodiments, the prioritization may also be specific to certain type of measurements. As another non-limiting example, in the scenario stated above, UWB range measurements may be given a higher priority over sidelink range measurements, which in turn g may be given a higher priority over Wi-Fi range measurements.

In some embodiments, if the hybrid cooperative positioning includes a sequential hybrid cooperative positioning session, the prioritization of measurements/technologies may also be determined based on link quality. For example, if the link quality information is available (e.g., if the link quality may be determined in terms of link budget parameters or the figure of merit indicated in the capability reports), only a subset of the measurements/technologies may be chosen for positioning, determined on a threshold-base. For example, only measurements/technologies with link qualities higher than a predetermined threshold may be performed by the sequential hybrid cooperative positioning session.

In some embodiments, the prioritization of measurements/technologies may also be determined based on positioning accuracy. For example, during the iterative steps of the sequential cooperative positioning scheme, if a UE has made various measurements using more than one technology in a previous iteration and observes that the position estimate obtained using each of the technologies alone converge to/diverge from a common estimate. The UE may determine a confidence metric accordingly and report the confidence metric to the server (e.g., using the capability report). The server may then prioritize such UE in the order of sequential positioning.

In some embodiments, the UE may be prioritized based on the number of unique measurements each UE supports. For example, the UEs and/or links that can make different types of measurements using various technologies can provide greater degree of freedom in terms of dilution of precision (DOP), more reliability, and more useful information for enhancing the position accuracy. Thus, the server may prioritize those UEs and/or links accordingly.

Accordingly, in the sequential hybrid cooperative positioning session configuration, measurements/technologies, anchors, and/or UEs with higher priority may be performed earlier in the sequence.

In some embodiments, the sequential hybrid cooperative positioning session configuration may also include information of resource allocations for each of UEs. For example, the resource allocations for each of UEs may include: (i) a time resource allocation, a frequency resource allocation, a spatial resource allocation, or any combination thereof; and (ii) an intended recipient for each ranging message. The sequential hybrid cooperative positioning session configuration may also include information of the number of iterations of the sequential hybrid cooperative positioning.

In some embodiments, if the hybrid cooperative positioning includes a joint hybrid cooperative positioning session, the prioritization of measurements/technologies may also be determined based on link quality. For example, if the link quality information is available (e.g., if the link quality may be determined in terms of link budget parameters or the figure of merit indicated in the capability reports), only a subset of the measurements/technologies may be chosen for positioning, determined on a threshold-base. For example, only measurements/technologies with link qualities higher than a predetermined threshold may be performed by the sequential hybrid cooperative positioning session.

In some embodiments, the prioritization of measurements/technologies may also be determined based on positioning accuracy. For example, during the iterative steps of the joint cooperative positioning scheme, if a UE has made various measurements using more than one technology in a previous iteration and observes that the position estimate obtained using each of the technologies alone converge to/diverge from a common estimate. The UE may determine a confidence metric accordingly and report the confidence metric to the server (e.g., using the capability report). The server may then include the UE with high priorities (e.g., a priority higher than a predetermined threshold) in the set of device-device measurements (e.g., the sidelink measurements portion 420-3 in FIG. 4) in joint hybrid cooperative positioning session.

In some embodiments, the UEs may be prioritized based on the number of unique measurements each UE supports. For example, the UEs and/or links that can make different types of measurements using various technologies can provide greater degree of freedom in terms of dilution of precision (DOP), more reliability, and more useful information for enhancing the position accuracy. Thus, the server may prioritize those UEs and/or links accordingly.

Accordingly, according to the joint hybrid cooperative positioning session configuration, the server may determine the inclusion/exclusion of measurements/technologies, anchor, and/or the UEs in the joint computation of the joint hybrid cooperative positioning session (e.g., in distance matrix 420 of FIG. 4). For example, measurements/technologies and/or the UEs with priorities lower than a predetermined threshold may be excluded from the joint computation of the joint hybrid cooperative positioning session.

In some embodiments, the joint hybrid cooperative positioning session configuration may also include information of resource allocations for each of the UEs. For example, the resource allocations for each of the UEs may include: (i) a time resource allocation, a frequency resource allocation, a spatial resource allocation, or any combination thereof; and (ii) an intended recipient for each ranging message.

At block 740, the functionality comprises transmitting, to the one or more participating UEs, the hybrid cooperative positioning session configuration (e.g., sequential or joint hybrid cooperative positioning session configuration) determined based on the device prioritization. Means for performing functionality at block 740 may comprise a bus 905, processor(s) 910, memory 935, wireless communication interface 933, and/or other components of computer system 900, as illustrated in FIG. 9.

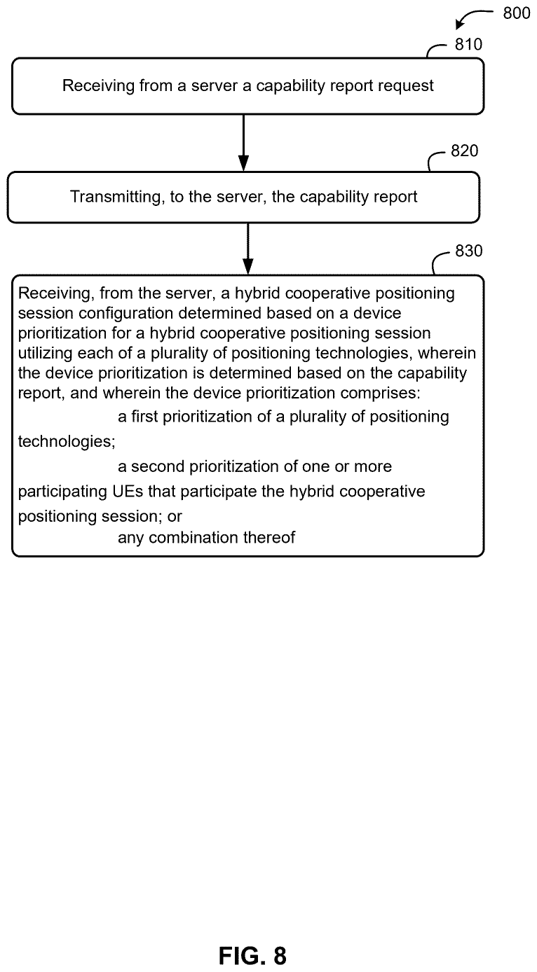

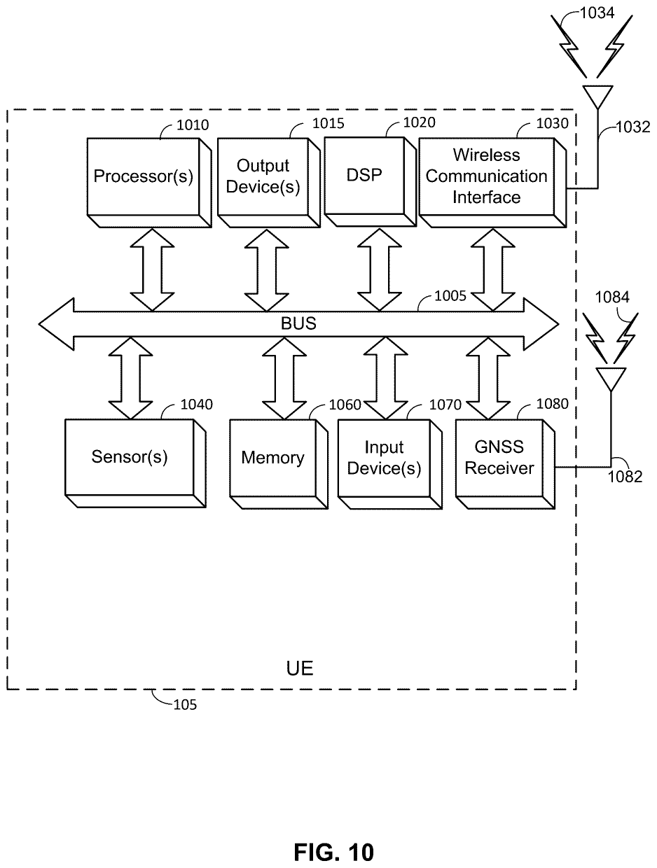

FIG. 8 is a method 800 of hybrid cooperative positioning performed by a UE, according to some embodiments. In some embodiments, the UE may be UEs capable of supporting different positioning technologies (e.g., UWB, Wi-Fi, 5G NR, Quadrotor Dead Reckoning (QDR), and/or visual positioning system) and may correspond with target device 205 or UWB device 240 of FIG. 2, mobile devices 145 or UE 105 of FIG. 1. Means for performing the functionality illustrated in one or more of the blocks shown in FIG. 8 may be performed by hardware and/or software components of a UE. Example components of UE 105 are illustrated in FIG. 10, which is described in more detail below.

At block 810, the functionality comprises receiving, from a server (e.g., server 505 in FIG. 5 or server 605 in FIG. 6), a capability report request. Means for performing functionality at block 810 may comprise a bus 1005, processor(s) 1010, memory 1060, wireless communication interface 1030, and/or other components of UE 105, as illustrated in FIG. 10.

At block 820, the functionality comprises transmitting, to the server, the capability report. In some embodiments, the capability report comprises parameters indicating: whether the UE intends to participate in a hybrid cooperative positioning session utilizing each of a plurality of positioning technologies; one or more of the plurality of positioning technologies supported by the UE; and one or more types of positioning measurements supported by the UE. Means for performing functionality at block 820 may comprise a bus 1005, processor(s) 1010, memory 1060, wireless communication interface 1030, and/or other components of UE 105, as illustrated in FIG. 10.

At block 830, the functionality comprises receiving, from the server, a hybrid cooperative positioning session configuration determined based on a device prioritization for a hybrid cooperative positioning session utilizing each of a plurality of positioning technologies, wherein the device prioritization is determined based on the capability report, and wherein the device prioritization comprises: a first prioritization of the plurality of positioning technologies; a second prioritization of one or more participating UEs that participate the hybrid cooperative positioning session; or any combination thereof. Means for performing functionality at block 830 may comprise a bus 1005, processor(s) 1010, memory 1060, wireless communication interface 1030, and/or other components of UE 105, as illustrated in FIG. 10.

In some embodiments, if the hybrid cooperative positioning includes a sequential hybrid cooperative positioning session, the prioritization of measurements/technologies may be determined based on link quality. For example, if the link quality information is available (e.g., if the link quality may be determined in terms of link budget parameters or the figure of merit indicated in the capability report), only a subset of the measurements/technologies may be chosen for positioning, determined on a threshold-base. For example, only measurements/technologies with link qualities higher than a predetermined threshold may be performed by the sequential hybrid cooperative positioning session.

In some embodiments, the prioritization of measurements/technologies may also be determined based on positioning accuracy. For example, during the iterative steps of the sequential cooperative positioning scheme, if a UE has made various measurements using more than one technology in a previous iteration and observes that the position estimate obtained using each of the technologies alone converge to/diverge from a common estimate. The UE may determine a confidence metric accordingly and report the confidence metric to the server (e.g., using the capability report). The server may then prioritize such UE in the order of sequential positioning.

In some embodiments, the UE may be prioritized based on the number of unique measurements each UE supports. For example, the UEs and/or links that can make different types of measurements using various technologies can provide greater degree of freedom in terms of dilution of precision (DOP), more reliability, and more useful information for enhancing the position accuracy. Thus, the server may prioritize those UEs and/or links accordingly.

Accordingly, in the sequential hybrid cooperative positioning session configuration, measurements/technologies, anchors, and/or UEs with higher priority may be performed earlier in the sequence.

In some embodiments, the sequential hybrid cooperative positioning session configuration may also include information of resource allocations for each of UEs. For example, the resource allocations for each of UEs may include: (i) a time resource allocation, a frequency resource allocation, a spatial resource allocation, or any combination thereof; and (ii) an intended recipient for each ranging message. The sequential hybrid cooperative positioning session configuration may also include information of the number of iterations of the sequential hybrid cooperative positioning.

In some embodiments, if the hybrid cooperative positioning includes a joint hybrid cooperative positioning session, the prioritization of measurements/technologies may also be determined based on link quality. For example, if the link quality information is available (e.g., if the link quality may be determined in terms of link budget parameters or the figure of merit indicated in the capability reports), only a subset of the measurements/technologies may be chosen for positioning, determined on a threshold-base. For example, only measurements/technologies with link qualities higher than a predetermined threshold may be performed by the sequential hybrid cooperative positioning session.

In some embodiments, the prioritization of measurements/technologies may also be determined based on positioning accuracy. For example, during the iterative steps of the joint cooperative positioning scheme, if a UE has made various measurements using more than one technology in a previous iteration and observes that the position estimate obtained using each of the technologies alone converge to/diverge from a common estimate. The UE may determine a confidence metric accordingly and report the confidence metric to the server (e.g., using the capability report). The server may then include the UE with high priorities (e.g., a priority higher than a predetermined threshold) in the set of device-device measurements (e.g., the sidelink measurements portion 420-3 in FIG. 4) in joint hybrid cooperative positioning session.

In some embodiments, the UEs may be prioritized based on the number of unique measurements each UE supports. For example, the UEs and/or links that can make different types of measurements using various technologies can provide greater degree of freedom in terms of dilution of precision (DOP), more reliability, and more useful information for enhancing the position accuracy. Thus, the server may prioritize those UEs and/or links accordingly.

Accordingly, according to the joint hybrid cooperative positioning session configuration, the server may determine the inclusion/exclusion of measurements/technologies, anchor, and/or the UEs in the joint computation of the joint hybrid cooperative positioning session (e.g., in distance matrix 420 of FIG. 4). For example, measurements/technologies and/or the UEs with priorities lower than a predetermined threshold may be excluded from the joint computation of the joint hybrid cooperative positioning session.

In some embodiments, the joint hybrid cooperative positioning session configuration may also include information of resource allocations for each of the UEs. For example, the resource allocations for each of the UEs may include: (i) a time resource allocation, a frequency resource allocation, a spatial resource allocation, or any combination thereof; and (ii) an intended recipient for each ranging message. The sequential hybrid cooperative positioning session configuration may also include information of the number of iterations of the hybrid cooperative positioning.

FIG. 9 is a block diagram of an embodiment of a computer system 900, which may be used, in whole or in part, to provide the functions of one or more network components as described in the embodiments herein (e.g., location server 160 of FIG. 1 server 505 in FIG. 5, or server 605 in FIG. 6). It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner. In addition, it can be noted that components illustrated by FIG. 9 can be localized to a single device and/or distributed among various networked devices, which may be disposed at different geographical locations.

The computer system 900 is shown comprising hardware elements that can be electrically coupled via a bus 905 (or may otherwise be in communication, as appropriate). The hardware elements may include processor(s) 910, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 900 also may comprise one or more input devices 915, which may comprise without limitation a mouse, a keyboard, a camera, a microphone, and/or the like; and one or more output devices 920, which may comprise without limitation a display device, a printer, and/or the like.

The computer system 900 may further include (and/or be in communication with) one or more non-transitory storage devices 925, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 900 may also include a communications subsystem 930, which may comprise wireless communication technologies managed and controlled by a wireless communication interface 933, as well as wired technologies (such as Ethernet, coaxial communications, universal serial bus (USB), and the like). The wireless communication interface 933 may comprise one or more wireless transceivers that may send and receive wireless signals 955 (e.g., signals according to 5G NR or LTE) via wireless antenna(s) 950. Thus the communications subsystem 930 may comprise a modem, a network card (wireless or wired), an infrared communication device, a wireless communication device, and/or a chipset, and/or the like, which may enable the computer system 900 to communicate on any or all of the communication networks described herein to any device on the respective network, including a User Equipment (UE), base stations and/or other TRPs, and/or any other electronic devices described herein. Hence, the communications subsystem 930 may be used to receive and send data as described in the embodiments herein.

In many embodiments, the computer system 900 will further comprise a working memory 935, which may comprise a RAM or ROM device, as described above. Software elements, shown as being located within the working memory 935, may comprise an operating system 940, device drivers, executable libraries, and/or other code, such as one or more applications 945, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 925 described above. In some cases, the storage medium might be incorporated within a computer system, such as computer system 900. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.), then takes the form of executable code.

FIG. 10 is a block diagram of an embodiment of a UE 105, which can be utilized as described herein above (e.g., in association with FIGS. 1-8). For example, the UE 105 can perform one or more of the functions of the method shown in FIG. 7 or 8. It should be noted that FIG. 10 is meant only to provide a generalized illustration of various components, any or all of which may be utilized as appropriate. It can be noted that, in some instances, components illustrated by FIG. 10 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 10.

The UE 105 is shown comprising hardware elements that can be electrically coupled via a bus 1005 (or may otherwise be in communication, as appropriate). The hardware elements may include a processor(s) 1010 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1010 may comprise one or more processing units, which may be housed in a single integrated circuit (IC) or multiple ICs. As shown in FIG. 10, some embodiments may have a separate DSP 1020, depending on desired functionality. Location determination and/or other determinations based on wireless communication may be provided in the processor(s) 1010 and/or wireless communication interface 1030 (discussed below). The UE 105 also can include one or more input devices 1070, which can include without limitation one or more keyboards, touch screens, touch pads, microphones, buttons, dials, switches, and/or the like; and one or more output devices 1015, which can include without limitation one or more displays (e.g., touch screens), light emitting diodes (LEDs), speakers, and/or the like.

The UE 105 may also include a wireless communication interface 1030, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 1030 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1032 that send and/or receive wireless signals 1034. According to some embodiments, the wireless communication antenna(s) 1032 may comprise a plurality of discrete antennas, antenna arrays, or any combination thereof. The antenna(s) 1032 may be capable of transmitting and receiving wireless signals using beams (e.g., Tx beams and Rx beams). Beam formation may be performed using digital and/or analog beam formation techniques, with respective digital and/or analog circuitry. The wireless communication interface 1030 may include such circuitry.

Depending on desired functionality, the wireless communication interface 1030 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA 2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 1040. Sensor(s) 1040 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 1080 capable of receiving signals 1084 from one or more GNSS satellites using an antenna 1082 (which could be the same as antenna 1032). Positioning based on GNSS signal measurement can be utilized to complement and/or incorporate the techniques described herein. The GNSS receiver 1080 can extract a position of the UE 105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1080 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1080 is illustrated in FIG. 10 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1010, DSP 1020, and/or a processor within the wireless communication interface 1030 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 1010 or DSP 1020.

The UE 105 may further include and/or be in communication with a memory 1060. The memory 1060 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1060 of the UE 105 also can comprise software elements (not shown in FIG. 10), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1060 that are executable by the UE 105 (and/or processor(s) 1010 or DSP 1020 within UE 105). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of hybrid cooperative positioning performed by a server, the method comprising: requesting a capability report from each user equipment (UE) of one or more UEs. The method also comprises receiving a set of one or more capability reports and determining, based on the one or more capability reports, a device prioritization for configuring the hybrid cooperative positioning session. The device prioritization comprises: a first prioritization of the plurality of positioning technologies, a second prioritization of one or more UEs that participate in the hybrid cooperative positioning session, or any combination thereof. The method also comprises transmitting, to the one or more UEs, a hybrid cooperative positioning session configuration determined based on the device prioritization.
Clause 2. The method of clause 1, wherein the set of one or more capability reports comprises a corresponding capability report from each of the one or more UEs, wherein, for each respective UE of the one or more UEs, the corresponding capability report comprises parameters indicating: whether the respective UE intends to participate in a hybrid cooperative positioning session utilizing each of a plurality of positioning technologies; one or more of the plurality of positioning technologies supported by the respective UE; and one or more types of positioning measurements supported by the respective UE.
Clause 3. The method of clause 1 or 2, wherein the first prioritization of the plurality of positioning technologies is determined based on a type of a positioning measurement determined by the hybrid cooperative positioning session.
Clause 4. The method of any of clauses 1-3, wherein the second prioritization for the one or more UEs is determined based on: a number of the types of the positioning measurements supported by each of the one or more UEs; a link quality of each of the one or more UEs; a positioning accuracy of each of the one or more UEs; or any combination thereof.
Clause 5. The method of any of clauses 1-4, wherein the positioning accuracy of each of the one or more UEs is determined based on estimations determined using different positioning measurements supported by the UE.
Clause 6. The method of any of clauses 1-5, wherein the hybrid cooperative positioning session configuration comprises: periodicity parameters of requesting or receiving the one or more capability reports.
Clause 7. The method of any of clauses 1-6, wherein the hybrid cooperative positioning session configuration further comprises: resource allocations for each of the one or more UEs, wherein the resource allocations for each of the one or more UEs comprises: (i) a time resource allocation, a frequency resource allocation, a spatial resource allocation, or any combination thereof; and (ii) an intended recipient for each ranging message.
Clause 8. The method of any of clauses 1-7, wherein the hybrid cooperative positioning session comprises a sequential cooperative positioning session, wherein the hybrid cooperative positioning session configuration further comprises: a number of positioning iterations for each of the one or more UEs; and a sequence of the one or more UEs, and wherein the method further comprises: receiving, from the one or more UEs, a request for providing position estimation of a corresponding UE; and transmitting, to the corresponding UE, the position estimation.
Clause 9. The method of any of clauses 1-8, wherein the hybrid cooperative positioning session comprises a joint cooperative positioning session, wherein the hybrid cooperative positioning session configuration further comprises: a number of the UEs included in the hybrid cooperative positioning session; and a number of anchor nodes included in the hybrid cooperative positioning session for positioning the included UEs, and wherein the method further comprises: receiving, from the one or more UEs, positioning measurements determined in accordance with the hybrid cooperative positioning session configuration; and transmitting, to a corresponding UE, position estimation determined based on the positioning measurements.
Clause 10. The method of any of clauses 1-9, wherein the plurality of positioning technologies comprises: Quadrotor Dead Reckoning (QDR); visual positioning system; Ultra-wideband (UWB); Wi-Fi; New Radio (NR); or any combination thereof.
Clause 11. The method of any of clauses 1-10, wherein the capability report further comprises; a number of anchor nodes known by the UE; a number of neighboring nodes known by the UE; a link budget parameter of the UE; or any combination thereof.
Clause 12. A method of hybrid cooperative positioning performed by a user equipment (UE), the method comprising: receiving, from a server, a capability report request and transmitting, to the server, the capability report. The method also comprises receiving, from the server, a hybrid cooperative positioning session configuration determined based on a device prioritization. The device prioritization is determined based on the capability report. The device prioritization comprises: a first prioritization of the plurality of positioning technologies, a second prioritization of one or more UEs that participate in the hybrid cooperative positioning session, or any combination thereof.
Clause 13. The method of clause 12, wherein the capability report further comprises parameters indicating: whether the UE intends to participate in a hybrid cooperative positioning session utilizing each of a plurality of positioning technologies; one or more of the plurality of positioning technologies supported by the UE; and one or more types of positioning measurements supported by the UE.
Clause 14. The method of clause 12 or 13, wherein the first prioritization of the plurality of positioning technologies is determined based on a type of a positioning measurement determined by the hybrid cooperative positioning session.
Clause 15. The method of any of clauses 12-14, wherein the second prioritization for the one or more UEs is determined based on: a number of the types of the positioning measurements supported by each of the one or more UEs; a link quality of each of the one or more UEs; a positioning accuracy of each of the one or more UEs; or any combination thereof.
Clause 16. The method of any of clauses 12-15, wherein the positioning accuracy of each of the one or more UEs is determined based on estimations determined using different positioning measurements supported by the UE.
Clause 17. The method of any of clauses 12-16, wherein the hybrid cooperative positioning session configuration comprises: periodicity parameters of requesting or receiving the one or more capability reports.
Clause 18. The method of any of clauses 12-17, wherein the hybrid cooperative positioning session configuration further comprises: resource allocations for each of the one or more UEs, wherein the resource allocations for each of the one or more UEs comprises: (i) a time resource allocation, a frequency resource allocation, a spatial resource allocation, or any combination thereof; and (ii) an intended recipient for each ranging message.
Clause 19. The method of any of clauses 12-18, wherein the hybrid cooperative positioning session comprises a sequential cooperative positioning session, and wherein the hybrid cooperative positioning session configuration further comprises: a number of positioning iterations for each of the one or more UEs; and a sequence of the one or more UEs, and wherein the method further comprises: transmitting, to the server, a request for position estimation of the UE; and receiving, from the server, the position estimation of the UE.
Clause 20. The method of any of clauses 12-19, wherein the hybrid cooperative positioning session comprises a joint cooperative positioning session, wherein the hybrid cooperative positioning session configuration further comprises: a number of the UEs included in the hybrid cooperative positioning session; and a number of anchor nodes included in the hybrid cooperative positioning session for positioning the included UEs, and wherein the method further comprises: receiving, from the one or more UEs, positioning measurements determined in accordance with the hybrid cooperative positioning session configuration; and transmitting, to a corresponding UE, position estimation determined based on the positioning measurements.
Clause 21. The method of any of clauses 12-20, wherein the plurality of positioning technologies comprises: Quadrotor Dead Reckoning (QDR); visual positioning system; Ultra-wideband (UWB); Wi-Fi; New Radio (NR); or any combination thereof.
Clause 22. The method of any of clauses 12-21, wherein the capability report further comprises; a number of anchor nodes known by the UE; a number of neighboring nodes known by the UE; a link budget parameter of the UE; or any combination thereof.
Clause 23. The method of any of clauses 12-22, wherein the link budget parameter of the UE comprises: a max transmission power of the UE; a number of transmitter antennas of the UE; a number of receiver antennas of the UE; a noise figure of the UE; a figure of merit of the UE; or any combination thereof.
Clause 24. An example server comprising: one or more transceivers, a memory, and one or more processors communicatively coupled with the one or more transceivers and the memory. The one or more processors are configured to: request a capability report from each user equipment (UE) of one or more UEs and receive a set of one or more capability reports. The one or more processors are also configured to determine, based on the one or more capability reports, a device prioritization for configuring the hybrid cooperative positioning session. The device prioritization comprises: a first prioritization of the plurality of positioning technologies, a second prioritization of one or more UEs that participate in the hybrid cooperative positioning session, or any combination thereof. The one or more processors are configured to transmit, to the one or more UEs, a hybrid cooperative positioning session configuration determined based on the device prioritization.
Clause 25. The server of clause 24, wherein the set of one or more capability reports comprises a corresponding capability report from each of the one or more UEs, wherein, for each respective UE of the one or more UEs, the corresponding capability report comprises parameters indicating: whether the respective UE intends to participate in a hybrid cooperative positioning session utilizing each of a plurality of positioning technologies; one or more of the plurality of positioning technologies supported by the respective UE; and one or more types of positioning measurements supported by the respective UE.
Clause 26. The server of clause 24 or 25, wherein the first prioritization of the plurality of positioning technologies is determined based on a type of a positioning measurement determined by the hybrid cooperative positioning session.
Clause 27. The server of any of clauses 24-26, wherein the second prioritization for the one or more UEs is determined based on: a number of the types of the positioning measurements supported by each of the one or more UEs; a link quality of each of the one or more UEs; a positioning accuracy of each of the one or more UEs; or any combination thereof.
Clause 28. A user equipment (UE) comprising: one or more transceivers, a memory, and one or more processors communicatively coupled with the one or more transceivers and the memory. The one or more processors are configured to: receive, from a server, a capability report request and transmit, to the server, the capability report. The one or more processors are also configured to receive, from the server, a hybrid cooperative positioning session configuration determined based on a device prioritization. The device prioritization is determined based on the capability report. The device prioritization comprises: a first prioritization of the plurality of positioning technologies, a second prioritization of one or more UEs that participate in the hybrid cooperative positioning session, or any combination thereof.
Clause 29. The server of clause 28, wherein the first prioritization of the plurality of positioning technologies is determined based on a type of a positioning measurement determined by the hybrid cooperative positioning session.
Clause 30. The server of clause 28 or 29, wherein the second prioritization for the one or more UEs is determined based on: a number of the types of the positioning measurements supported by each of the one or more UEs; a link quality of each of the one or more UEs; a positioning accuracy of each of the one or more UEs; or any combination thereof.

1. A method of hybrid cooperative positioning performed by a server, the method comprising:
requesting a capability report from each user equipment (UE) of one or more UEs;
receiving a set of one or more capability reports;
determining, based on the one or more capability reports, a device prioritization for configuring a hybrid cooperative positioning session utilizing each of a plurality of positioning technologies, wherein the device prioritization comprises:
a first prioritization of the plurality of positioning technologies;
a second prioritization of one or more UEs that participate in the hybrid cooperative positioning session; or
any combination thereof; and
transmitting, to the one or more UEs, a hybrid cooperative positioning session configuration determined based on the device prioritization.

2. The method of claim 1. wherein the set of one or more capability reports comprises a corresponding capability report from each of the one or more UEs, wherein, for each respective UE of the one or more UEs, the corresponding capability report comprises parameters indicating:
whether the respective UE intends to participate in the hybrid cooperative positioning session;
one or more of the plurality of positioning technologies supported by the respective UE; and
one or more types of positioning measurements supported by the respective UE.

3. The method of claim 1, wherein the first prioritization of the plurality of positioning technologies is determined based on a type of a positioning measurement determined by the hybrid cooperative positioning session.

4. The method of claim 1, wherein the second prioritization for the one or more UEs is determined based on:
a number of types of positioning measurements supported by each of the one or more UEs;
a link quality of each of the one or more UEs;
a positioning accuracy of each of the one or more UEs; or any combination thereof.

5. The method of claim 4, wherein the positioning accuracy of each of the one or more UEs is determined based on positioning estimations determined using different positioning measurements supported by the UE.

6. The method of claim 1, wherein the hybrid cooperative positioning session configuration comprises:
periodicity parameters of requesting or receiving the one or more capability reports.

7. The method of claim 6, wherein the hybrid cooperative positioning session configuration further comprises:
resource allocations for each of the one or more UEs, wherein the resource allocations for each of the one or more UEs comprises:
(i) a time resource allocation,
a frequency resource allocation,
a spatial resource allocation, or
any combination thereof; and
(ii) an intended recipient for each ranging message.

8. The method of claim 7, wherein the hybrid cooperative positioning session comprises a sequential cooperative positioning session, wherein the hybrid cooperative positioning session configuration further comprises:
a number of positioning iterations for each of the one or more UEs; and a sequence of the one or more UEs, and wherein the method further comprises:
receiving, from the one or more UEs, a request for providing position estimation of a corresponding UE; and
transmitting, to the corresponding UE, the position estimation.

9. The method of claim 7, wherein the hybrid cooperative positioning session comprises a joint cooperative positioning session, wherein the hybrid cooperative positioning session configuration further comprises:
a number of the UEs included in the hybrid cooperative positioning session; and
a number of anchor nodes included in the hybrid cooperative positioning session for positioning the included UEs, and wherein the method further comprises:
receiving, from the one or more UEs, positioning measurements determined in accordance with the hybrid cooperative positioning session configuration; and
transmitting, to a corresponding UE, position estimation determined based on the positioning measurements.

10-11. (canceled)

12. A method of hybrid cooperative positioning performed by a user equipment (UE), the method comprising:
receiving, from a server, a request for a capability report;
transmitting, to the server, the capability report; and
receiving, from the server, a hybrid cooperative positioning session configuration determined based on a device prioritization for a hybrid cooperative positioning session utilizing each of a plurality of positioning technologies, wherein the device prioritization is determined based on the capability report, and wherein the device prioritization comprises:
a first prioritization of a plurality of positioning technologies; a second prioritization of one or more UEs that participate in the hybrid cooperative positioning session; or
any combination thereof.

13. The method of claim 12, wherein the capability report further comprises parameters indicating:
whether the UE intends to participate in the hybrid cooperative positioning session;
one or more of the plurality of positioning technologies supported by the UE; and
one or more types of positioning measurements supported by the UE.

14. The method of claim 12, wherein the first prioritization of the plurality of positioning technologies is determined based on a type of a positioning measurement determined by the hybrid cooperative positioning session.

15. The method of claim 12, wherein the second prioritization for the one or more UEs is determined based on:
a number of types of positioning measurements supported by each of the one or more UEs;
a link quality of each of the one or more UEs;
a positioning accuracy of each of the one or more UEs; or any combination thereof.

16. The method of claim 15, wherein the positioning accuracy of each of the one or more UEs is determined based on estimations determined using different positioning measurements supported by the UE.

17. The method of claim 12, wherein the hybrid cooperative positioning session configuration comprises:
periodicity parameters of requesting or receiving the capability report.

18. The method of claim 17, wherein the hybrid cooperative positioning session configuration further comprises:
a periodicity of requesting the capability report;
resource allocations for each of the one or more UEs, wherein the resource allocations for each of the one or more UEs comprises:
(i) a time resource allocation,
a frequency resource allocation,
a spatial resource allocation, or
any combination thereof; and
(ii) an intended recipient for each ranging message.

19. The method of claim 18, wherein the hybrid cooperative positioning session comprises a sequential cooperative positioning session, and wherein the hybrid cooperative positioning session configuration further comprises:
a number of positioning iterations for each of the one or more UEs; and a sequence of the one or more UEs, and wherein the method further comprises:
transmitting, to the server, a request for position estimation of the UE; and
receiving, from the server, the position estimation of the UE.

20. The method of claim 18, wherein the hybrid cooperative positioning session comprises a joint cooperative positioning session, wherein the hybrid cooperative positioning session configuration further comprises:
a number of the UEs included in the hybrid cooperative positioning session; and
a number of anchor nodes included in the hybrid cooperative positioning session for positioning included UEs, and wherein the method further comprises:
transmitting, to the server, positioning measurements determined in accordance with the hybrid cooperative positioning session configuration; and
receiving, from the server, position estimation determined based on the positioning measurements.

21-27. (canceled)

28. A user equipment (UE) comprising:
one or more transceivers;
a memory; and
one or more processors communicatively coupled with the one or more transceivers and the memory, wherein the one or more processors are configured to:
receive, from a server, a request for a capability report; transmit, to the server, the capability report; and
receive, from the server, a hybrid cooperative positioning session configuration determined based on a device prioritization for a hybrid cooperative positioning session utilizing each of a plurality of positioning technologies, wherein the device prioritization is determined based on the capability report, and wherein the device prioritization comprises:
a first prioritization of the plurality of positioning technologies;
a second prioritization of one or more UEs that participate in the hybrid cooperative positioning session; or
any combination thereof.

29. (canceled)

30. The UE of claim 28, wherein the second prioritization for the one or more UEs is determined based on:
a number of types of positioning measurements supported by each of the one or more UEs;
a link quality of each of the one or more UEs;
a positioning accuracy of each of the one or more UEs; or any combination thereof.
